(19) United States
(12) Patent Application Publication
(10) Pub. No.: US 2009/0041281 A1
(43) Pub. Date: Feb. 12, 2009

(54) LOW-FREQUENCY SOUND ADJUSTABLE EARPHONE

(76) Inventor: Wan-Hsiang Chang, Hsintien City (TW)

Correspondence Address: PAI PATENT & TRADEMARK LAW FIRM, 1001 FOURTH AVENUE, SUITE 3200, SEATTLE, WA, 98154, US

(21) Appl. No.: 11/837,094

(22) Filed: Aug. 10, 2007

(51) Int. Cl. H04R 1/02

(52) U.S. Cl. 381/345

(57) ABSTRACT

A low-frequency sound adjustable earphone is disclosed which includes a housing, which has a resonance chamber and a crevice in air communication between the resonance chamber and the atmosphere, a speaker mounted inside the housing for converting an electronic voice signal into sound for amplification by the resonance chamber, and an adjustment cap, which is pivoted to the housing and rotatable to adjust the air path defined in the crevice and to further adjust the output sound.

### BACKGROUND OF THE INVENTION

1. Field of the Invention

The present invention relates to earphones and more particularly to a low-frequency sound adjustable earphone, which allows adjustment of low frequency sound mechanically without any extra electronic circuit.

2. Description of the Related Art

Modern mobile digital music players (MP3 player or the like) are popular due to the advantages of small size and high storage capacity. For output of high sound quality, a mobile digital music player shall be used with a high quality earphone. There are earphones with low-frequency sound output that have a resonating chamber for oscillation of low frequency sound. However, these earphones do not allow the user to adjust the volume of the low frequency sound. Adjustment of the volume of the low frequency sound can only be done by means of an internal circuit design of the mobile music player. In case the user's mobile music player does not provide a low/high frequency signal adjustment function, the user can only accept the voice output of the attached earphone.

### SUMMARY OF THE INVENTION

The present invention has been accomplished under the circumstances in view. One object of the present invention is to provide an earphone which allows adjustment of the sound of its low-frequency output.

To achieve this and other objects of the present invention, the low-frequency sound adjustable earphone comprises a housing, which defines therein a resonance chamber, and a speaker mounted inside the housing for converting an electronic voice signal into sound for amplification by the resonance chamber. The housing further comprises a crevice disposed in communication between the resonance chamber and the atmosphere to provide an air path, and an adjustment cap pivotally coupled to an outside wall thereof. The adjustment cap has a through hole movable with the adjustment cap relative to the crevice to adjust the size of the air path, thereby adjusting the output sound.

### BRIEF DESCRIPTION OF THE DRAWINGS

FIG. 1 is an exploded view of a low-frequency sound adjustable earphone in accordance with the present invention.

FIG. 2 is a perspective assembly view of the low-frequency sound adjustable earphone in accordance with the present invention.

FIG. 3 is a schematic sectional view of the low-frequency sound adjustable earphone in accordance with the present invention.

FIG. 4 is a schematic drawing showing a status of adjustment of the low-frequency sound adjustable earphone in accordance with the present invention (I).

FIG. 5 is a schematic drawing showing a status of adjustment of the low-frequency sound adjustable earphone in accordance with the present invention (II).

### DETAILED DESCRIPTION OF THE PREFERRED EMBODIMENT

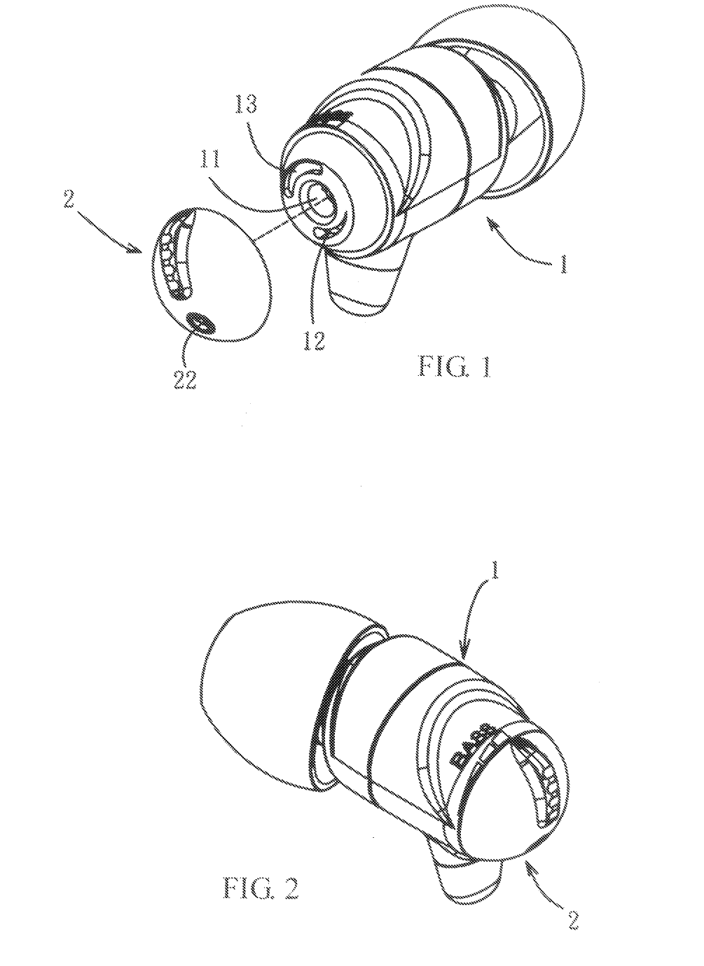

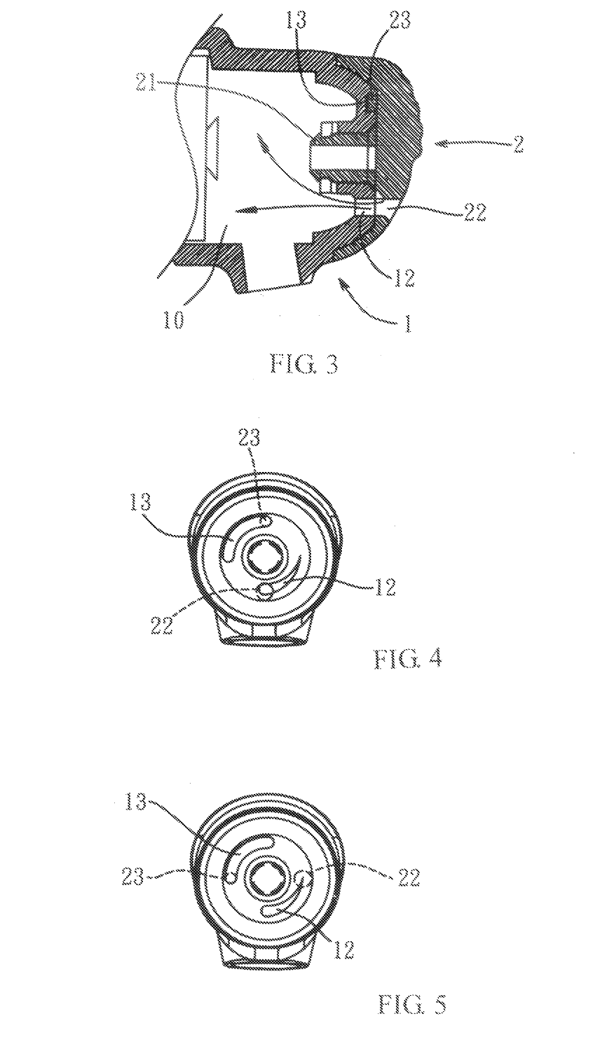

Referring to FIGS. 1˜3, a low-frequency sound adjustable earphone in accordance with the present invention is insertable into the ear of a person to convert an electronic audio frequency signal into sound. The low-frequency sound adjustable earphone comprises a housing 1, a speaker (not shown) mounted inside the housing 1, and an adjustment cap 2.

The housing 1 comprises a resonance chamber 10 that amplifies sound through resonance, a pivot hole 11 at the center of the rear end, and a crevice 12 extending around the pivot hole 11 in air communication with the resonance chamber 10. According to this embodiment, the crevice 12 has a smoothly curved cross section that reduces gradually in width from one end to the other, showing the shape of a waterdrop.

The adjustment cap 2 has a pivot axle 21 coupled to the pivot hole 11 for allowing rotation of the adjustment cap 2 relative to the housing 1, and a circular through hole 22 of a predetermined area in a position corresponding to the crevice 12 of the housing 1.

Referring to FIGS. 4 and 5, the user can rotate the adjustment cap 2 relative to the housing 1 to change the position of the circular through hole 22 relative to the crevice 12. When the circular through hole 22 is moved with the adjustment cap 2 relative to the housing 1 toward the relatively wider end of the crevice 12, a relatively broader air path is provided for air to pass at a relatively larger rate of flow (see FIG. 4). On the contrary, when the circular through hole 22 is moved with the adjustment cap 2 relative to the housing 1 toward the relatively narrower end of the crevice 12, a relatively narrower air path is provided for air to pass at a relatively lower rate of flow (see FIG. 5). Therefore, the user can rotate the adjustment cap 2 relative to the housing 1 to adjust the flow of air passing through the crevice 12 and to further adjust the amplification of sound in the resonance chamber 10.

The housing 1 further comprises a smoothly arched sliding slot 13 extending around the pivot hole 11. The adjustment cap 2 further has a guide rod 23 inserted into the sliding slot 13 to guide rotation of the adjustment cap 2 relative to the housing 1 and to limit the angle of rotation of the adjustment cap 2 relative to the housing 1. Therefore, the circular through hole 22 is constantly kept in communication with the crevice 12.

Although a particular embodiment of the invention has been described in detail for purposes of illustration, various modifications and enhancements may be made without departing from the spirit and scope of the invention.

The invention claimed is:

1. An earphone comprising a housing, said housing defining therein a resonance chamber and comprising a crevice disposed in communication between said resonance chamber and the atmosphere to provide an air path; a speaker mounted inside said housing for converting an electronic voice signal into sound for amplification by said resonance chamber; and an adjustment cap pivotally coupled to an outside wall of said housing, said adjustment cap having a through hole movable with said adjustment cap relative to said crevice to adjust the size of said air path.

2. The earphone as claimed in claim 1, wherein said crevice has a first end and a second end opposite to said first end, and a width gradually reducing from said first end toward said second end.

3. The earphone as claimed in claim 1, wherein said housing further comprises a smoothly arched sliding slot; said adjustment cap has a guide rod inserted into said sliding slot to guide movement of said adjustment cap relative to the outside wall of said housing.
